(19) United States
(12) Patent Application Publication
(10) Pub. No.: US 2004/0252967 A1
(43) Pub. Date: Dec. 16, 2004

(54) Mutlimedia play interface control device

(76) Inventors: Joe Sheu, Hsin-Chu (TW); PC Huang, Hsin Chu (TW); Kono Lin, Hsinchu (TW); Bingo Teng, Hsinchu (TW); Michue Sun, Hsinchu City (TW); Charles Chung, Hsinchu (TW); YW Chang, Banciao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/653,089

(22) Filed: Sep. 3, 2003

(30) Foreign Application Priority Data
Jun. 13, 2003 (JP) 92210836

(51) Int. Cl. H04N 5/781

(52) U.S. Cl. 386/46; 386/125

(57) ABSTRACT

A multimedia play interface control device comprises a central processor, which controls actions of a memory card interface and an optical disc read/write interface. The central processor lets the memory card interface switch to a compatible interface for connecting a memory card having a different specification, and lets the optical disc read/write interface performs read/write actions to an optical disc. In other words, the single central processor is used to control read/write of memory cards and optical discs for integrating read/write of several kinds of storage media. The effect of multimedia play by a single device can thus be achieved. Moreover, the advantages of convenient use, small size and multiple selection can be accomplished.

### FIELD OF THE INVENTION

The present invention relates to a storage media control device and, more particularly, to a multimedia play interface control device capable of controlling read of memory cards and optical discs.

### BACKGROUND OF THE INVENTION

Along with the continual progress of the information technology, various kinds of electronic information products like mobile phones, notebook computers, digital cameras and DVD players provide different applications such as audio/video multimedia and data transmission via network in everyday lives of people. These electronic products generally need to access various kinds of electronic data. Therefore, data storage media play a very important role. Among data storage media, memory cards and optical discs of large capacity and convenient replacement provide various kinds of data for card readers and optical disc players.

There are many specifications of memory cards like secured digital (SD), compact flash (CF). and memory stick (MS). Although manufacturers have provided adaptors capable of inserting different memory cards for connection to an electronic device, users needs to additionally purchase a memory adaptor for reading different kinds of memory cards.

Moreover, conventional players like DVD players, MP3 players or card readers are separate devices. When one wants to watch a movie, he connects a DVD player or a card reader to a television for playing the read audio/video data. When he wants to listen to music, he connects a DVD player, an MP3 player or a card reader to a loudspeaker for playing sound. Because optical discs and memory cards are popular storage media nowadays, if one wants to make use of a television for simultaneously playing audio/video data in optical discs or memory cards, he needs to externally connect a DVD player or a card reader with the television together. For people more and more appreciating the quality of life, the connection of many electronic devices will occupy much space. Also, many entangled electric wires are annoying.

Accordingly, in order to meet the requirement of modern people for play of multimedia, the present invention aims to propose a multimedia play interface control device to solve the problems and inconvenience in the prior art.

### SUMMARY AND OBJECTS OF THE PRESENT INVENTION

The primary object of the present invention is to provide a multimedia play interface control device, which integrates a memory card interface and an optical disc read/write interface and makes use of a single central processor for processing multimedia data, thereby accomplishing the effect of read/write of several kinds of storage media by using a single device.

Another object of the present invention is to propose a multimedia play interface control device, which provides flexible selection of storage media to accomplish both effects of convenience and small size, thereby solving the inconvenience and trouble of external wire connection in the prior art.

Yet another object of the present invention is to provide a multimedia play interface control device having a high added value so that users need not to additionally purchase a card reader or an optical disc player, hence accomplishing the advantage of a lower cost.

To achieve the above objects, the present invention comprises a memory card interface used for connection with memory cards of different specifications. The memory card interface is connected to a central processor. The central processor is used for detection of the interface format of the memory card connected with the memory card interface and read/write of memory cards of different specifications via the memory card interface. The read data are then played by an output medium. An optical disc read/write interface is connected to the central processor, and performs read/write actions to an optical disc according to control instructions of the central processor. The read data are then played by the output medium. In other words, a single central processor is used to integrate multimedia audio/video data, which are then played by an output medium.

The various objects and advantages of the present invention will be more readily understood from the following detailed description when read in conjunction with the appended drawings, in which:

### BRIEF DESCRIPTION OF DRAWING

FIG. 1 is a structure block diagram of the present invention;

FIG. 2 is a flowchart for reading a memory card of the present invention;

FIG. 3 is a diagram showing a main menu frame of the present invention; and

FIG. 4 is a diagram showing a file list menu frame of the present invention.

### DETAILED DESCRIPTION OF PREFERRED EMBODIMENT

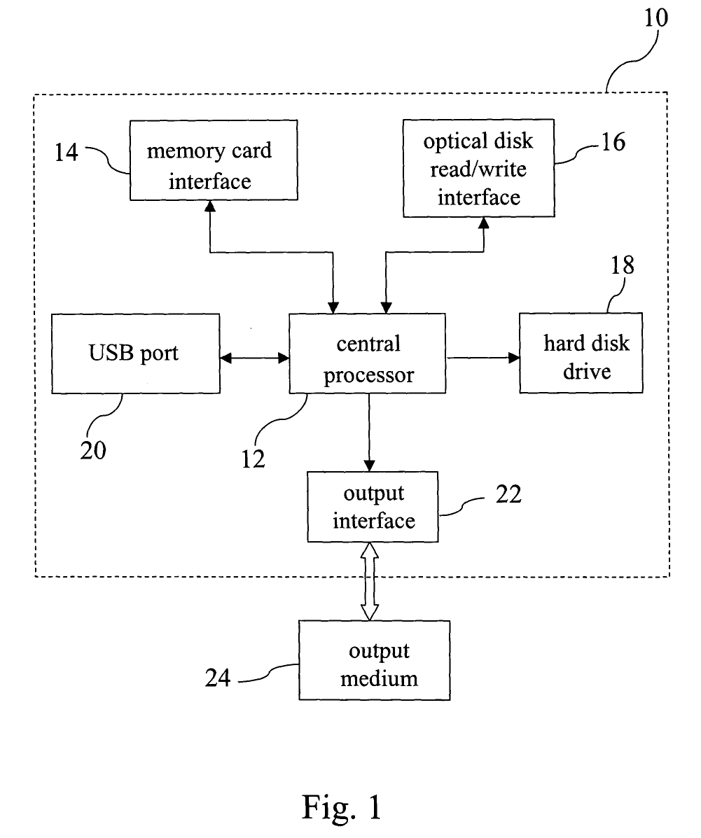

As shown in FIG. 1, a multimedia play interface control device 10 comprises a central processor 12 used for control and integration of other components in the multimedia play interface control device 10. The central processor 12 is connected to a memory card interface 14, an optical disc read/write interface 16, a hard disk drive 18, a USB port 20 and an output interface 22. Through these connections, the central processor 12 can process data in several kinds of storage media and then output multimedia audio/video data via the output interface 22 for play.

The memory card interface 14 can be a memory card slot for insertion of a memory card or two or more memory cards, and can also be a connection interface for forming signal connection with a memory card. The memory card interface 14 is used to switch to interfaces for connection with memory cards of different specification including secured digital (SD) cards, multimedia cards (MMC), smart media (SM) cards, memory stick (MS) cards, compact flash (CF) cards, XD-picture cards and microdrives. After the central processor 12 detects the interface format of a memory card connected with the memory card interface 14, it launches an instruction to let the memory card interface 14 switch to an interface corresponding to the memory card. The central processor 12 can then read/write data in different memory cards through connection of the memory card interface and then output the read audio/video data via the output interface 22. The optical disc read/write interface 16 is generally an optical disc drive for placement of an optical disc, and performs read/write actions to the optical disc according to instructions of the central processor 12. The optical read/written by the optical disc read/write interface 16 is generally of DVD, VCD, CD or MP3 format. The hard disk drive 18 is used for storage of data. The central processor 12 stores data inputted from the memory card interface 14, the optical disc read/write interface 16 or the USB port 20 into the hard disk drive 18, or controls the memory card interface 14, the optical disc read/write interface 16 and the hard disk drive to intercommunicate data. The USB port 20 generally comprises a USB interface and a USB connector, and is used to transmit data with other electronic devices having a USB port via a USB transmission line.

The output interface 22 is used to achieve electric connection with an output medium 24 so that the central processor 12 can play the read multimedia audio/video data on the output medium 24 through connection of the output interface 22. The output medium 24 is generally one having a display and a loudspeaker, and can also be a television. When the output medium 24 connected with the output interface 22 is used to output analog signals, the central processor 12 decompresses the read multimedia audio/video data to obtain digital data and then converts the digital data into analog audio/video data, which are sent to the output medium 24 via the output interface 22 for play. When the output medium 24 connected with the output interface 22 is used to output digital signals, the central processor 12 decompresses the read multimedia audio/video data to obtain digital data and then directly send the digital data to the output medium 24 for play.

Through the above structure, the central processor 12 controls actions of the memory card interface 14 or the optical disc read/write interface to let the memory card interface read data in a memory card or the optical disc read/write interface 16 read data in an optical disc. Moreover, the central processor 12 sends the read audio/video data to the output medium 24 via the output interface 22 for display of video or simultaneous play of sound by a loudspeaker. The audio/video data processed by the central processor 12 include video files, audio files, audio/video files and game files. In other words, the central processor 12 integrates multimedia audio/video data into an output medium 24 for play. Therefore, the multimedia play interface control device 10 proposed by the present invention has both the optical disc read/write function and memory card read/write function, and can further utilize the output medium 24 for play of read audio/video data, and can even make use of the USB port 20 for intercommunication of data with a computer.

Besides, because floppy discs are still widespread storage media, the central processor 12 can further be connected with a floppy disc read/write interface for read/write of a floppy disc, hence providing more selections for users.

In application, the multimedia play interface control device 10 can be a separate device connected with the output medium 24, or can be integrally arranged in the output medium 24.

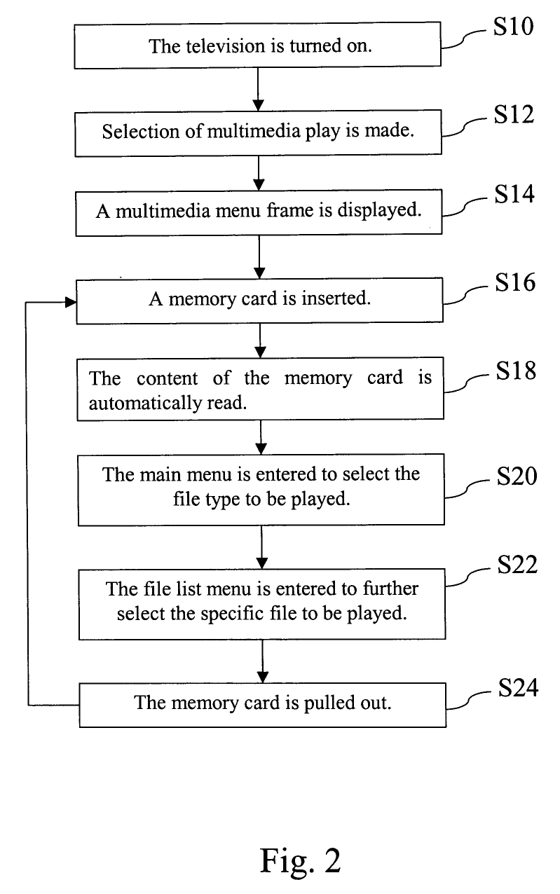

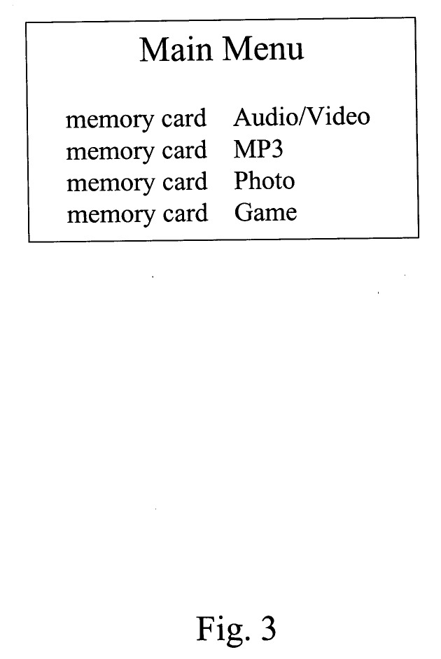

The multimedia play flow process of memory card and optical disc read of the present invention will be exemplified below with the multimedia play interface control device 10 connected with a television. FIG. 2 shows the memory card read and play flow process. First, after a user makes sure that the television is connected with the multimedia play interface control device 10, he sends out a command via a key module or a remote controller to turn on the television (Step S10). He then uses the remote controller to select the multimedia play function (S12), and the central processor 12 starts functioning to let the television display a multimedia play menu frame (S14). Next, the user inserts a memory card to connect the memory card interface 14 (S16). The central processor 12 then automatically reads the content of the memory card and classifies files in the memory card (S18). If the memory card stores audio/video files of format supportable by the central processor 12 like DAT files, MP3 files or JPG files, the central processor 12 enters a main menu and drives the television to display a main menu frame shown in FIG. 3. The user can then use the remote controller to select the file type to be played from the main menu frame displayed by the television (S20).

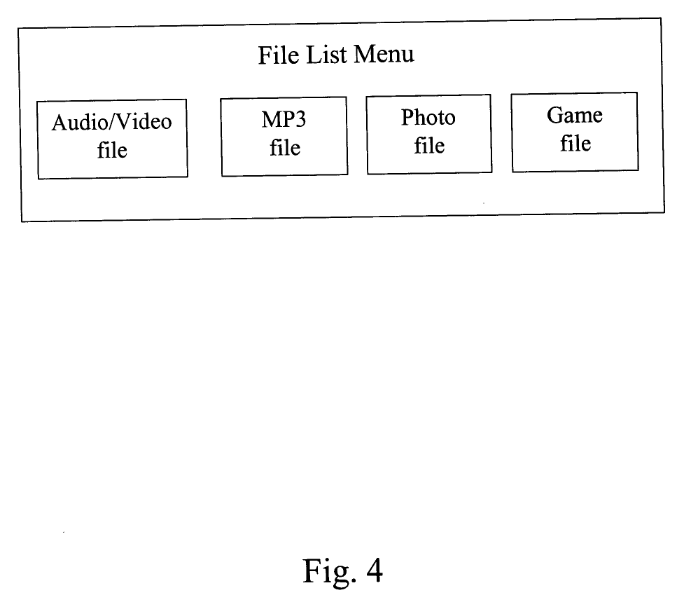

After the user selects the file type to be played, the central processor 12 enters a file list menu and drives the television to display a file list menu frame shown in FIG. 4 (S22). The file list menu displays all file types in the memory card including an Audio/Video menu, an MP3 menu, a Photo menu and a Game menu. At this time, the user can further select the specific file to be played from one of these menus. If the user wants to change the memory card in operation, he can directly extracts the memory card and then inserts another memory card (S24), and repeats the above steps S16 to S22 to let the central processor 12 read the content in the memory card.

In Step 22, after the user selects the specific file to be played from one of the menus, the central processor 12 automatically reads data in the memory card and decompresses the read data, and then converts the decompressed digital data into analog audio/video signals acceptable by the television. Next, the television plays the analog audio/video signals. If the television is digital, no signal conversion is required for the decompressed digital data, which can be directly played.

The multimedia play flow process of optical disc read is similar. The insertion action of a memory card into the memory card interface 14 is changed to the placement action of an optical disc in the optical disc read/write interface 16. The menu selection actions between the central processor 12 and the optical disc read/write interface 16 are the same as in the above flow process and thus will not be further described. After the user selects the specific file to be played from one of the menus, the central processor 12 automatically sends a drive instruction to the optical disc read/write interface 16 to let the optical disc read/write interface 16 automatically read data in the optical disc. The optical disc read/write interface 16 then transfers the read audio/video data to the central processor 12 for decompression. The digital data after decompression are then converted into analog audio/video signals acceptable by the television. Next, the television plays the analog audio/video signals. Similarly, if the television is digital, no signal conversion is required for the decompressed digital data, which can be directly played.

To sum up, the present invention integrates memory card and optical disc read media into a multimedia play interface control device, and makes use of a single central processor for processing multimedia data, thereby accomplishing the effect of read/write of several kinds of storage media by using a single device. The present invention also provides flexible selection of storage media to accomplish both effects of convenience and small size. Moreover, that users need not to additionally purchase a card reader or an optical disc player, hence simultaneously accomplishing the advantage of a high added value and a lower cost.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A multimedia play interface control device comprising:
a memory card interface for switching to a different interface to connect a memory card having a different specification;
a central processor for detection of the interface format of a memory card connected with said memory card interface to let said memory card interface switch to a corresponding interface, said central processor further performing read/write of different kinds of memory cards via said memory card interface and processing read data to be played by an output medium; and
an optical disc read/write interface connected to said central processor, said optical disc read/write interface performing read/write actions to an optical disc according to control instructions of said central processor;
whereby said central processor can integrate read/write and play of multimedia data.

2. The multimedia play interface control device as claimed in claim 1, wherein said memory card interface is a memory card slot.

3. The multimedia play interface control device as claimed in claim 1, wherein said memory card interface is a connection interface.

4. The multimedia play interface control device as claimed in claim 1, wherein said memory card is selected among the group composed of secured digital cards, multimedia cards, smart media cards, memory stick cards, compact flash cards, XD-picture cards and microdrives.

5. The multimedia play interface control device as claimed in claim 1, wherein the format of said optical disc read/written by said optical disc read/write interface is selected among the group composed of DVD, VCD, CD and MP3.

6. The multimedia play interface control device as claimed in claim 1, wherein said central processor is further connected with a hard disk drive,

7. The multimedia play interface control device as claimed in claim 6, wherein said multimedia data processed by said central processor come from said memory card, said optical disc or said hard disk drive, and said multimedia data are selected among the group composed of video files, audio files, audio/video files and game files.

8. The multimedia play interface control device as claimed in claim 1, wherein said central processor is further connected with an output interface, and said central processor achieves electric connection with said output medium via said output interface.

9. The multimedia play interface control device as claimed in claim 1, wherein said output medium is selected among the group composed of a display, a loudspeaker and a television.

10. The multimedia play interface control device as claimed in claim 1, wherein said central processor decompresses said read multimedia data to obtain digital data and converts said digital data into analog signals, which are then played by said output medium.

11. The multimedia play interface control device as claimed in claim 1, wherein said central processor decompresses said read multimedia data to obtain digital data, which are then played by said output medium.

12. The multimedia play interface control device as claimed in claim 1, wherein said central processor is further connected with a USB port.

13. The multimedia play interface control device as claimed in claim 1, wherein said central processor is further connected with a disk read/write interface.
